(19) United States
(12) Patent Application Publication
(10) Pub. No.: US 2025/0012568 A1
(43) Pub. Date: Jan. 9, 2025

(54) FLOOD WARNING SYSTEM

(71) Applicant: J. M. TORRES & ASSOCIATES, LLC, College Station, TX (US)

(72) Inventors: JACOB M. TORRES, College Station, TX (US); JACK R. LANOIS, College Station, TX (US)

(73) Assignee: J. M. TORRES & ASSOCIATES, LLC, College Station, TX (US)

(21) Appl. No.: 18/888,124

(22) Filed: Sep. 17, 2024

Related U.S. Application Data
(63) Continuation-in-part of application No. 17/702,787, filed on Mar. 24, 2022, now Pat. No. 12,094,320.
(60) Provisional application No. 63/287,025, filed on Dec. 7, 2021.

(51) Int. Cl. G01C 13/00; G01W 1/00; G01W 1/14

(52) U.S. Cl. CPC G01C 13/008; G01W 1/14; G01W 2001/006

(57) ABSTRACT

A system for monitoring flooding can include a plurality of flood monitoring stations and at least one flood warning station in communication with each flood monitoring station. Each flood monitoring station can include at least one water level sensor and at least one rainfall sensor. Each flood monitoring station can determine a water level at a periodic rate and compare the water level to a threshold, determine a rainfall accumulation at a periodic rate and compare the rainfall accumulation to a threshold, assign a threat level to the flood monitoring station, and selectively communicate a data packet to the flood warning station.

### CROSS-REFERENCE TO RELATED APPLICATIONS

This application is a continuation-in-part of U.S. patent application Ser. No. 17/702,787 filed Mar. 24, 2022, which claims the benefit of U.S. Provisional Patent Application No. 63/287,025 filed Dec. 7, 2021, the entire contents of which are hereby incorporated herein by reference.

### TECHNICAL FIELD

The present disclosure relates generally to adverse weather detection and warning systems and more specifically relates to systems and methods for providing warnings of impending or actual flooding conditions.

### BACKGROUND

The United States Geological Survey currently monitors a variety of stream gauges throughout the United States. These stream gauges monitor various conditions, such as depth and flow rates. However, their placement and configuration is not necessarily well suited to monitoring or predicting flooding, such as the flooding of roadways, especially in rural communities and/or roadways outside of urban areas.

Flooding, in general, can be dangerous and disruptive. Roadway flooding is particularly dangerous when drivers do not appreciate the dangers and try to drive through floodwaters. Drivers may not realize a particular roadway is flooded, or about to flood, and therefore may become trapped, even where another roadway is clear. Thus, a flooded roadway can cause congestion even where alternative routes are available.

### SUMMARY

Applicants have created new and useful devices, systems and methods for monitoring impending or actual flooding conditions. In at least one embodiment, a system for monitoring flooding can include a plurality of flood monitoring stations and at least one flood warning station in communication with each flood monitoring station. Each flood monitoring station can include at least one water level sensor and at least one rainfall sensor. Each flood monitoring station can determine a water level at a periodic rate and compare the water level to a threshold, determine a rainfall accumulation at a periodic rate and compare the rainfall accumulation to a threshold, assign a threat level to the flood monitoring station, and selectively communicate a data packet to the flood warning station. Embodiments of the disclosure can, among other things, advantageously improve response time, extend battery life, improve flood monitoring accuracy, and/or provide for flood monitoring in geographic areas despite the absence of physical water level sensors in such areas.

In at least one embodiment, a system for monitoring flooding according to the disclosure can include a plurality of flood monitoring stations and at least one flood warning station in communication with each flood monitoring station. Each flood monitoring station can include at least one water level sensor and at least one rainfall sensor. Each flood monitoring station can include a housing, a processor and a wireless communications device. In at least one embodiment, each flood monitoring station can determine a water level at a periodic rate and compare the water level to a threshold, determine a rainfall accumulation at a periodic rate and compare the rainfall accumulation to a threshold, assign a threat level to the flood monitoring station, and selectively communicate a data packet to the flood warning station. In at least one embodiment, a data packet can include at least one of a most recent water level, a most recent rainfall accumulation, an assigned threat level, or any combination thereof. In at least one embodiment, a flood warning station can include a user interface and can be arranged for selectively controlling one or more operational or other aspects of one or more flood monitoring stations.

In at least one embodiment, one or more flood monitoring stations can determine whether an assigned threat level is above a minimum threat level threshold, and communicate a data packet to the flood warning station if the assigned threat level exceeds the minimum threat level threshold. In at least one embodiment, one or more flood monitoring stations can include a measurement type identifier in the data packet, and the measurement type identifier can be indicative of a type of measurement that caused an assigned threat level to exceed the minimum threat level threshold. In at least one embodiment, one or more flood monitoring stations can include a sensor identifier in a data packet, and the sensor identifier can be indicative of which sensor sensed the measurement that caused the assigned threat level to exceed the minimum threat level threshold. In at least one embodiment, one or more flood monitoring stations can determine a rate of change in the water level and/or rainfall accumulation, compare the rate(s) of change to a rate threshold(s), and increase one or more measurement rates based on such a comparison, such as if a rate of change is greater than or equal to a rate threshold.

In at least one embodiment, one or more flood monitoring stations can be disposed adjacent or otherwise in operable proximity to a corresponding waterbody with one or more water level sensors disposed in sensing communication with a corresponding waterbody. In at least one embodiment, a system can include or have access to a database including flood data, such as water level sensor data, rainfall accumulation data, historical weather data, electronically stored model data, such as for a geographic area located distally from one or more flood monitoring stations, or any combination thereof. In at least one embodiment, a system can estimate, for a geographic area, at least one of a location of flooding, a depth of flooding, a time of flooding, or any combination thereof, such as based at least in part on data in the database. In at least one embodiment, a system can display, such as on a graphical user interface, at least one of a location of flooding, a depth of flooding, a time of flooding, a likelihood of flooding, or any combination thereof, for one or more geographic areas.

In at least one embodiment, a system can determine a flood criticality for one or more geographic areas. In at least one embodiment, a flood criticality can be indicative of a likelihood that flooding will occur in one or more geographic areas. In at least one embodiment, a system can display one or more flood criticalities, such as on one or more graphical user interfaces. In at least one embodiment, electronically stored model data for one or more geographic areas can include flood data, such as flood estimation data. In at least one embodiment, flood data can include data resulting from the application of one or more electronically stored rainstorm models to an electronically stored model of a geographic area.

In at least one embodiment, a method for monitoring flooding according to the disclosure can include providing a plurality of flood monitoring stations, each flood monitoring station including a water level sensor and a rainfall sensor, and providing a flood warning station in wireless communication with the plurality of flood monitoring stations. In at least one embodiment, a method can include determining a water level with a water level sensor at a periodic rate and comparing the water level to a threshold, and determining a rainfall accumulation with a rainfall sensor at a periodic rate and comparing the rainfall accumulation to a threshold. In at least one embodiment, a method can include assigning a threat level to a flood monitoring station based on at least one of the comparisons. In at least one embodiment, a method can include communicating, from one or more flood monitoring stations to a flood warning station, one or more data packets. In at least one embodiment, a data packet can include a most recent water level, a most recent rainfall accumulation, an assigned threat level, or any combination thereof.

In at least one embodiment, a method can include determining whether an assigned threat level is above a minimum threat level threshold, and communicating a data packet to a flood warning station if the assigned threat level exceeds the minimum threat level threshold. In at least one embodiment, a method can include including a measurement type identifier in a data packet, such as a measurement type identifier indicative of a type of measurement that caused an assigned threat level to exceed a minimum threat level threshold. In at least one embodiment, a method can include including a sensor identifier in a data packet, such as a sensor identifier indicative of which sensor sensed a measurement that caused an assigned threat level to exceed a minimum threat level threshold. In at least one embodiment, a method can include determining a rate of change in a water level and/or rainfall accumulation, comparing a rate of change to a threshold, and increasing a measurement rate if the rate of change is greater than or equal to the threshold.

In at least one embodiment, a method can include estimating, for a geographic area, such as an area located distally from one or more flood monitoring stations, a location of flooding, a depth of flooding, a time of flooding, or any combination thereof. In at least one embodiment, an estimation can be based at least in part on one or more determined water levels and/or rainfall accumulations. In at least one embodiment, a method can include displaying at least one of a location of flooding, a depth of flooding, a time of flooding, or any combination thereof, on a graphical user interface, such as of a flood warning station.

In at least one embodiment, a method can include determining a flood criticality for a geographic area, which can be a flood criticality indicative of a likelihood that flooding will occur in the geographic area. In at least one embodiment, a method can include displaying flood criticality on a graphical user interface. In at least one embodiment, a geographic area can include one or more roadways or portions thereof.

In at least one embodiment, a method can include creating an electronically stored model of a geographic area, creating an electronically stored model of a rainstorm, and applying the electronically stored model of the rainstorm to the electronically stored model of the geographic area. In at least one embodiment, a method can include dynamically updating a flood criticality for a geographic area, such as based at least in part on measured data during a weather event, historical data, modeled data, or any combination thereof. In at least one embodiment, a method can include accessing a database including water level sensor data, rainfall accumulation data, historical weather data, or any combination thereof, and creating an electronically stored predictive model of a geographic area. In at least one embodiment, a method can include triangulating flooding along a roadway segment or other geographic area, such as based at least in part on one or more of measurements from one or more flood monitoring stations. In at least one embodiment, a method can include displaying, on a graphical user interface, a visual representation of flooding of one or more roadway segments.

### BRIEF DESCRIPTION OF THE DRAWINGS

FIG. 1 is a simplified diagram of one of many embodiments of a stream gauge map according to the disclosure.

FIG. 2 is the diagram of FIG. 1 overlaid with a simplified road network.

FIG. 3 is the diagram of FIG. 2 showing potential low water crossings, and thus potential roadway flooding points.

FIG. 4 is a simplified diagram of one of many embodiments of a flood monitoring station according to the disclosure.

FIG. 5 is an image of one of many embodiments of a sensor assembly for use with a flood monitoring station according to the disclosure.

FIG. 6 is an image of one of many embodiments of a flood monitoring station according to the disclosure.

FIG. 7 is an image of one of many embodiments of a controller for use with a flood monitoring station according to the disclosure.

FIG. 8 is an image of another one of many embodiments of a flood monitoring station according to the disclosure.

FIG. 9 is a simplified diagram of one of many embodiments of a flood monitoring system according to the disclosure.

FIG. 10 is a simplified diagram of another one of many embodiments of a flood monitoring system according to the disclosure.

FIG. 11 is a simplified diagram of still another of many embodiments of a flood monitoring system according to the disclosure.

FIG. 12 is a simplified diagram of one of many embodiments of a flood monitoring map according to the disclosure.

FIG. 13 is the diagram of FIG. 12 showing one flood monitoring station warning of flooding.

FIGS. 14-16 are flowcharts showing some of many embodiments of methods for providing warnings of impending or actual flooding conditions according to the disclosure.

FIG. 17 is a simplified diagram illustrating aspects of one of many embodiments of a flood monitoring system according to the disclosure.

FIG. 18 is a simplified diagram illustrating aspects of one of many embodiments of a control panel for a flood monitoring system according to the disclosure.

FIG. 19 is a simplified diagram illustrating aspects of one of many embodiments of an asset management platform for a flood monitoring system according to the disclosure.

FIG. 20 is a simplified diagram illustrating aspects of one of many embodiments of a data analytics dashboard for a flood monitoring system according to the disclosure.

FIG. 21 is a simplified diagram of one of many embodiments of a flood monitoring system according to the disclosure.

FIG. 22 is a simplified diagram of one of many embodiments of a flood monitoring map illustrating flood criticality according to the disclosure.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Process flowcharts discussed herein illustrate the operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, blocks shown in succession may, in fact, be executed concurrently or at least substantially concurrently. It will also be noted that each block of a flowchart illustration can be implemented by special purpose hardware-based systems that perform the specified functions or acts, or combinations of special purpose hardware and computer instructions.

Applicants have created new and useful devices, systems and methods for monitoring impending and/or actual flooding conditions. In at least one embodiment, devices, systems and methods of the present disclosure advantageously can provide for a decentralized, industrial, Internet of Things (IoT) solution that is readily scalable and two-way operable for automatically detecting flooded roadways and which can be configured for long-term historical data retrieval. In at least one embodiment, devices, systems and methods of the present disclosure advantageously can provide for a comprehensive web-based product including functionality such as flood monitoring, monitoring flood warnings, mobile text message notification services, dispatching of road closure crews and informing community residents or travelers of potentially dangerous conditions via flasher beacons and/or other warning mechanisms. In at least one embodiment, a flood warning system according to the disclosure can include data collection and logging at the ground station level via an appropriately programmed microcontroller and a web-based software application in communication with one or more ground stations for taking one or more actions based on or in light of data collected.

In at least one embodiment, a method for monitoring flooding can include determining a water level at one or more flood monitoring stations, communicating water level information from each flood monitoring station to a flood warning station, and warning one or more users of actual or potential flooding in one or more locations when one or more water levels approaches or exceeds one or more thresholds. In at least one embodiment, a flood monitoring station can include at least one pressure transducer or other sensor configured to detect water level, whether separately or in combination with one or more other sensors. Water level can be sensed constantly, periodically or otherwise, and in at least one embodiment, water level sensing and/or the frequency thereof can depend at least partially on one or more variables or conditions, such as the presence of one or more environmental conditions conducive to flooding.

In at least one embodiment, a system for monitoring flooding can include a plurality of flood monitoring stations and at least one flood warning station in communication with each flood monitoring station. Each flood monitoring station can include at least one water level sensor and at least one rainfall sensor. Each flood monitoring station can determine a water level at a periodic rate and compare the water level to a threshold, determine a rainfall accumulation at a periodic rate and compare the rainfall accumulation to a threshold, assign a threat level to the flood monitoring station, and selectively communicate a data packet to the flood warning station. Embodiments of the disclosure can, among other things, advantageously improve response time, extend battery life, improve flood monitoring accuracy, and/or provide for flood monitoring in geographic areas despite the absence of physical water level sensors in such areas. Illustrative embodiments of the disclosure are described in more detail below with reference to the accompanying drawings.

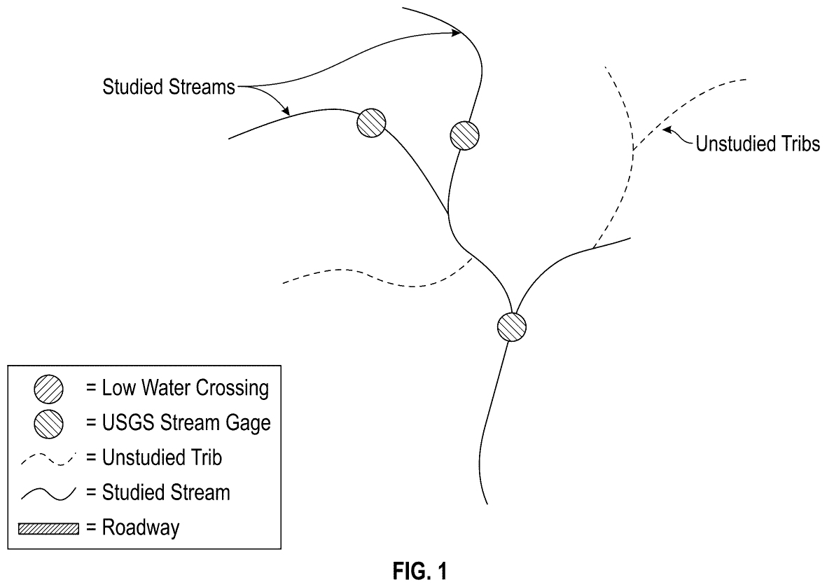

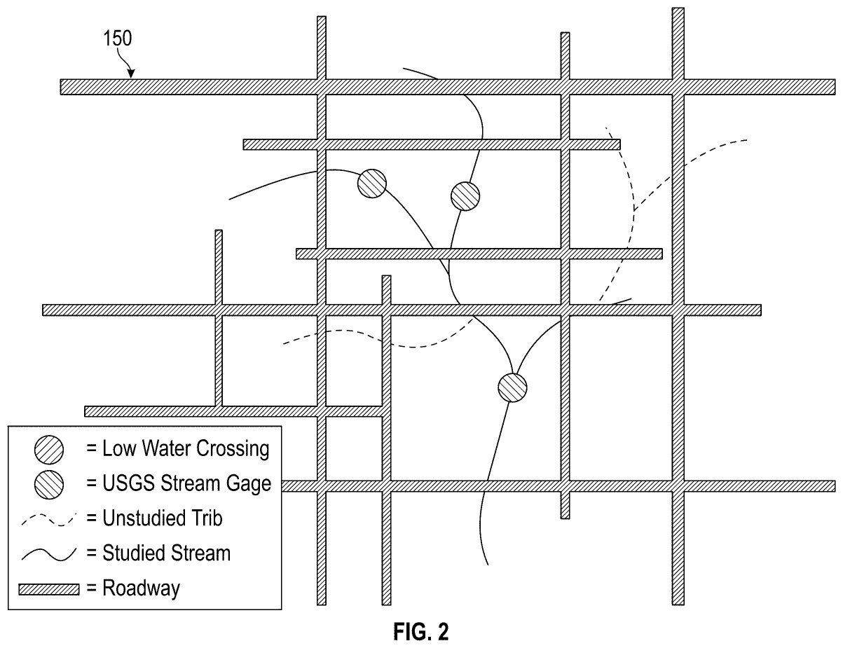

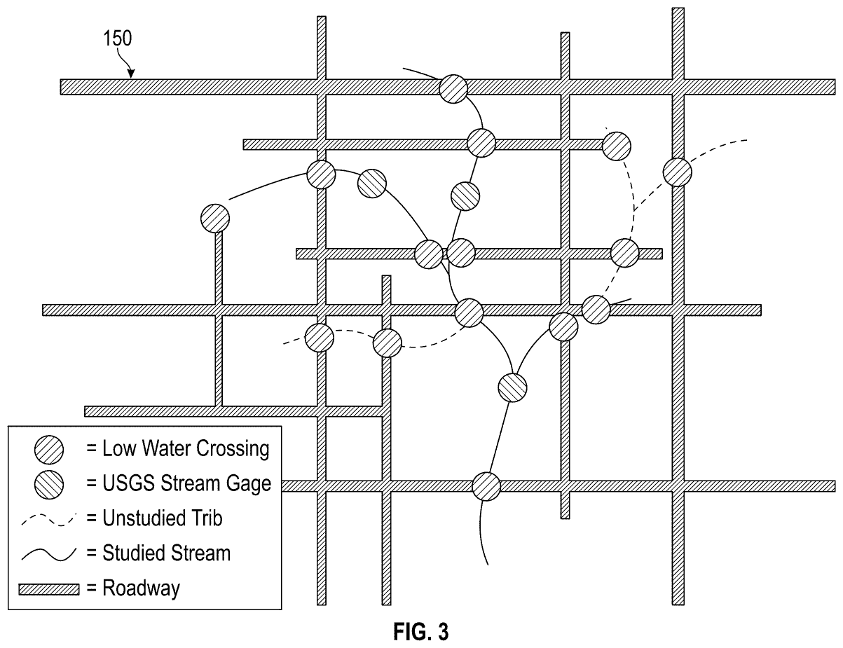

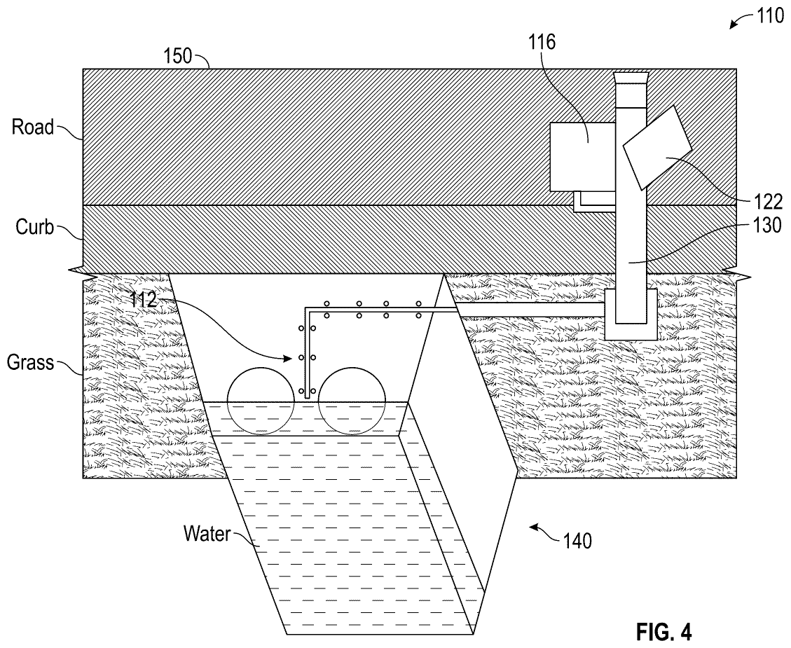

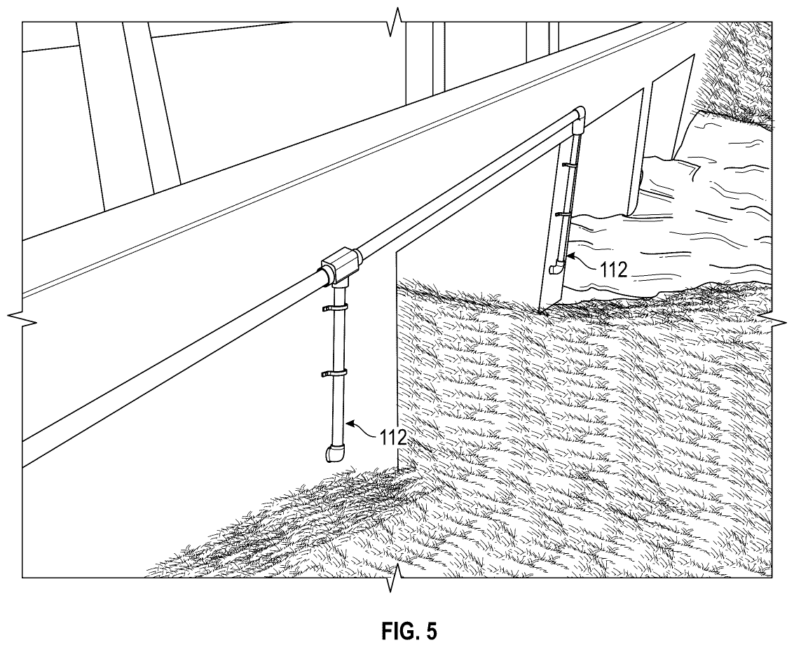

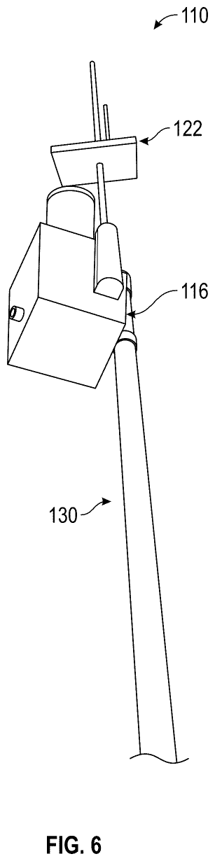

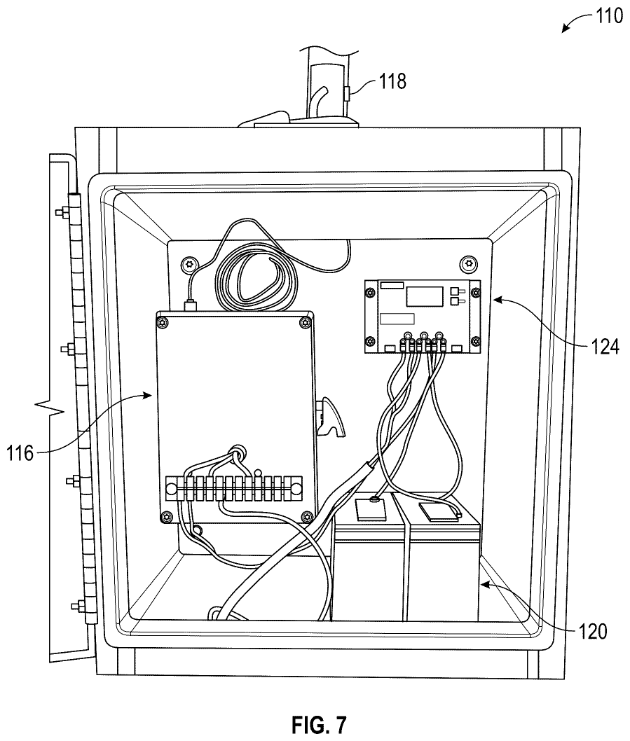

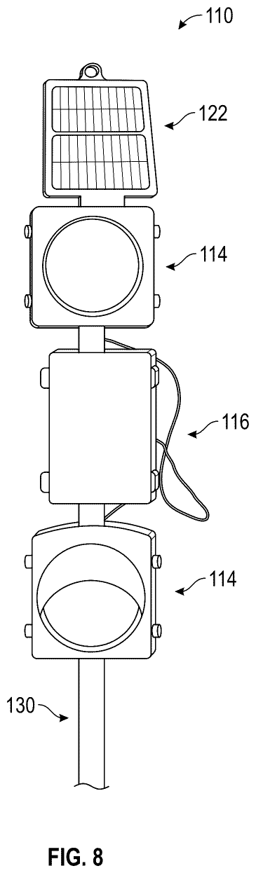

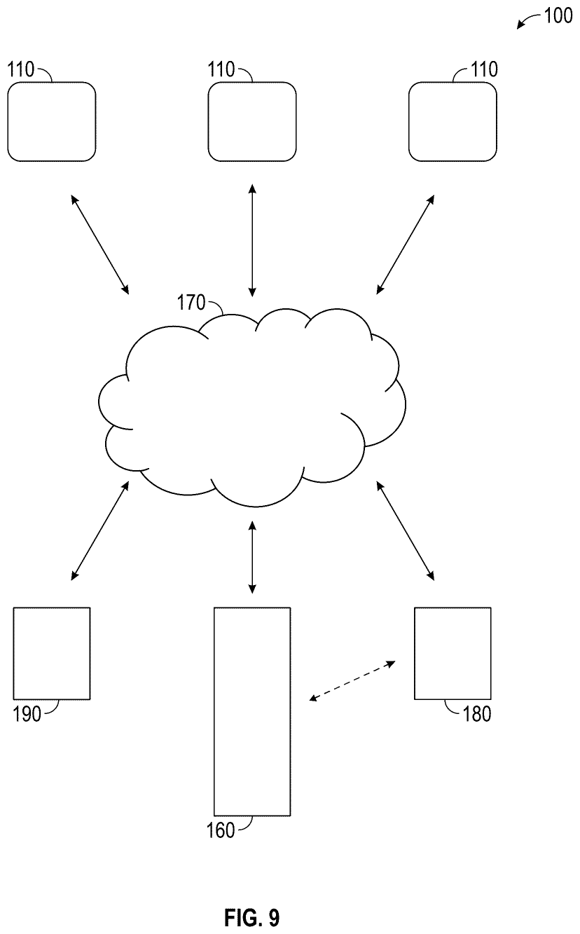

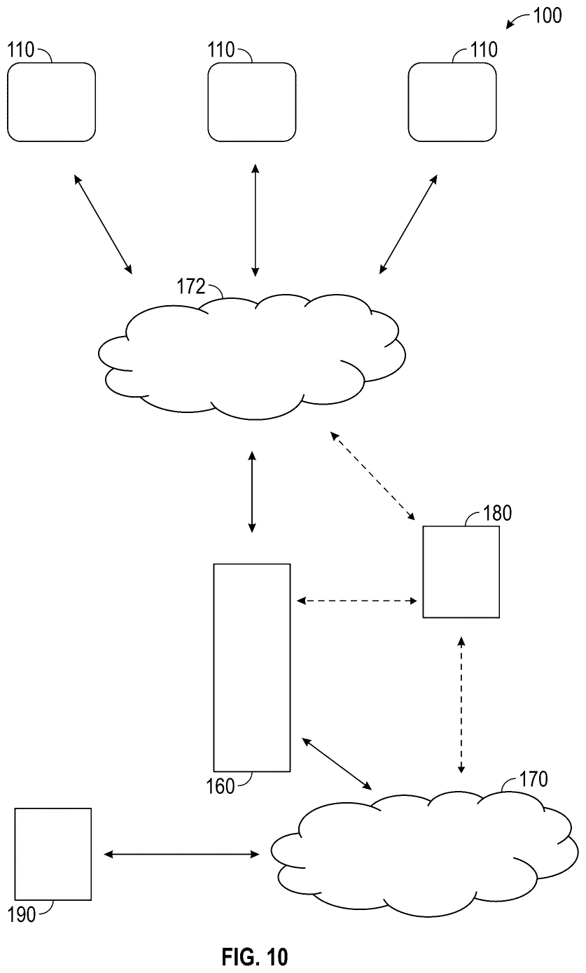

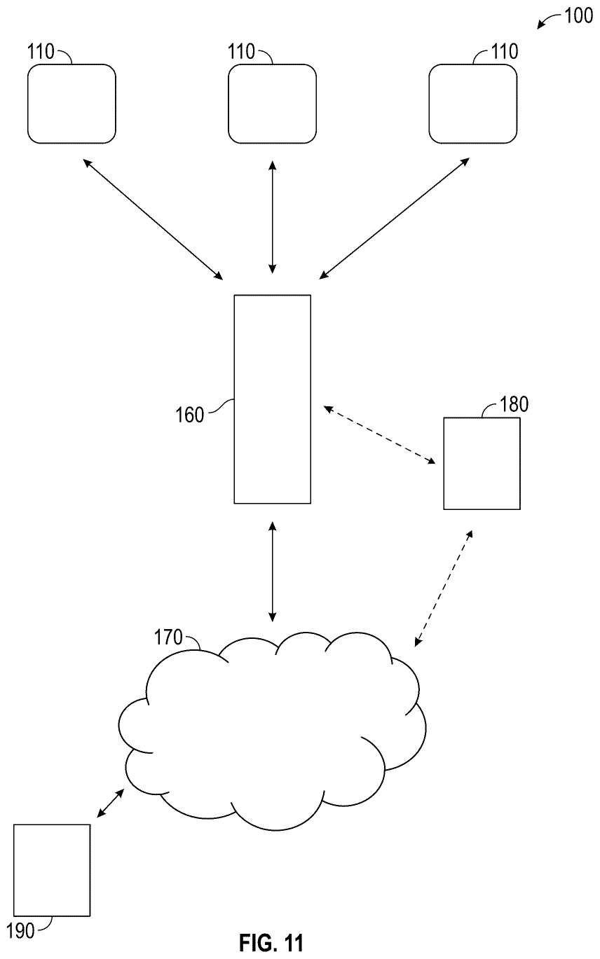

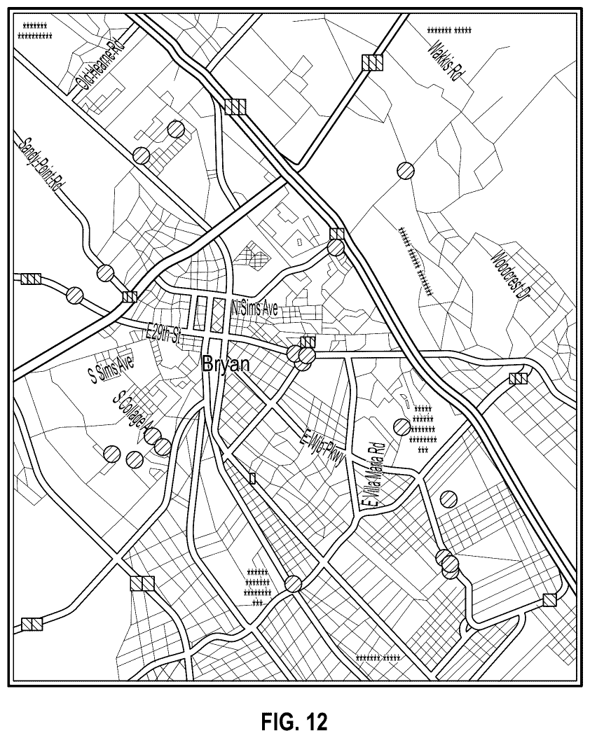

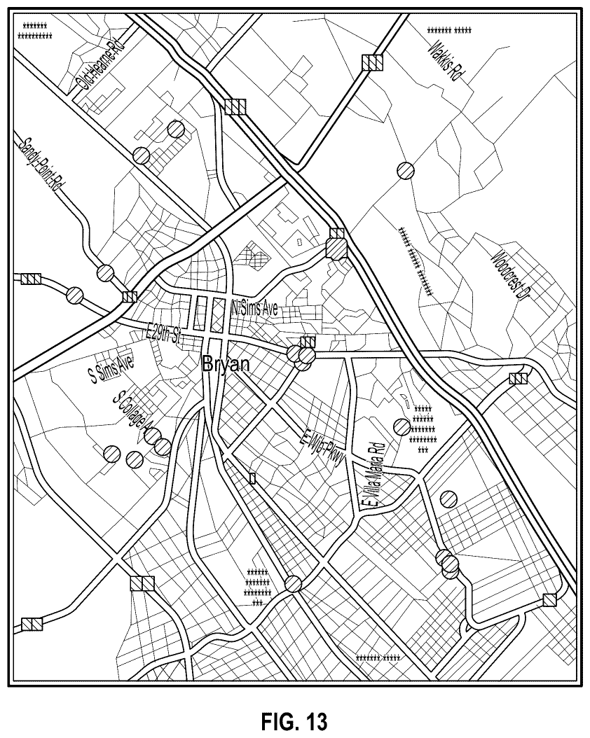

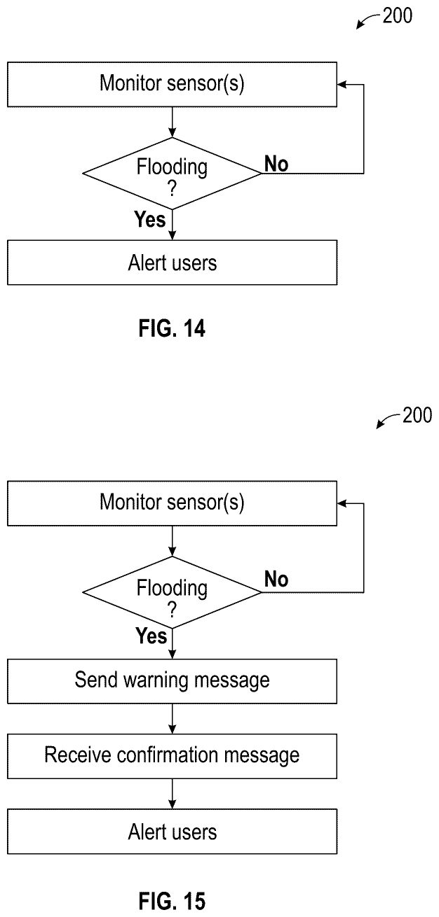

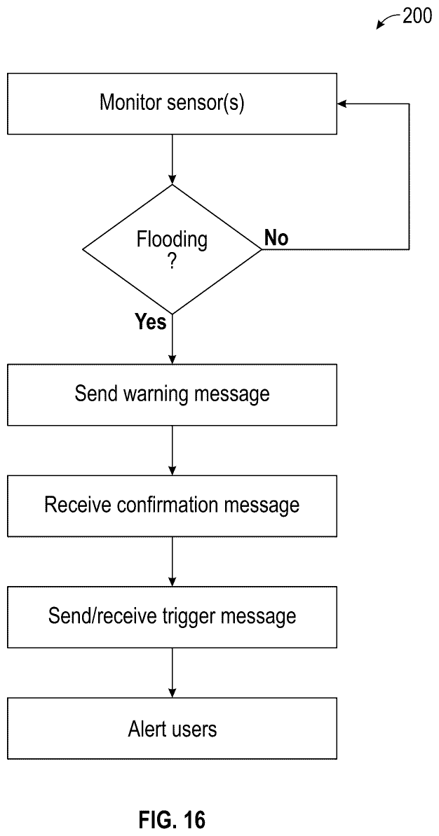

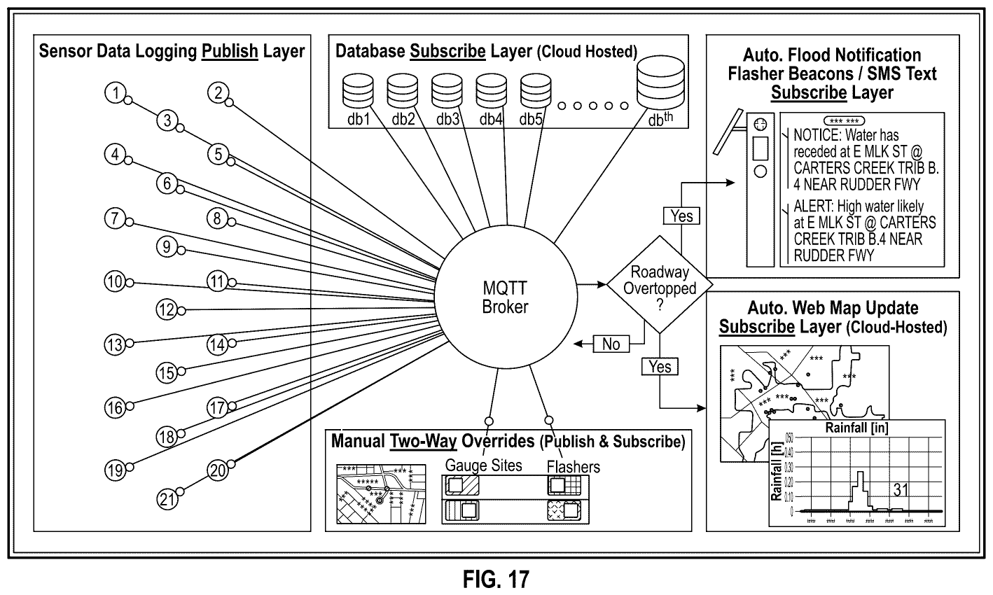

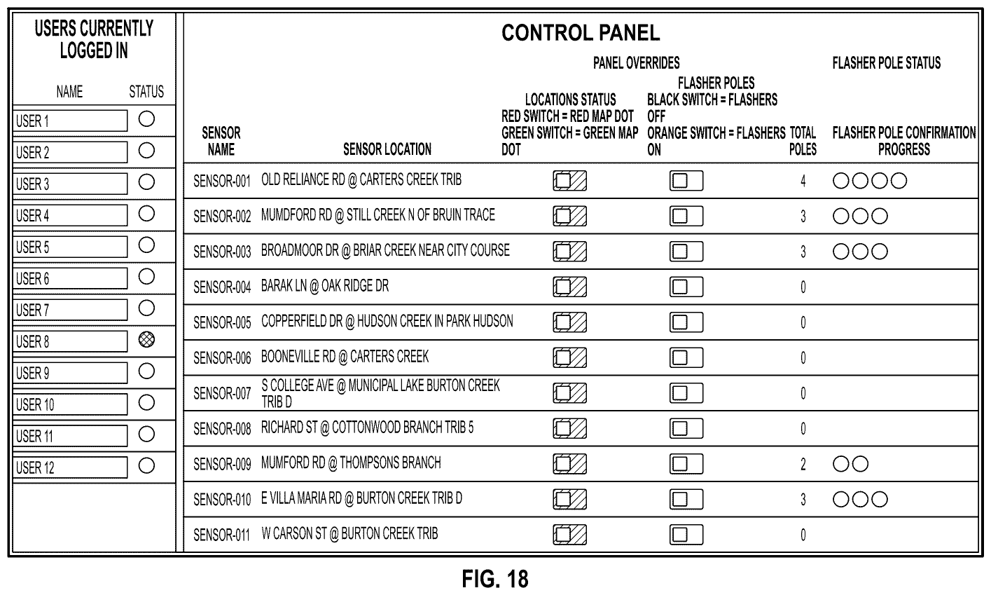

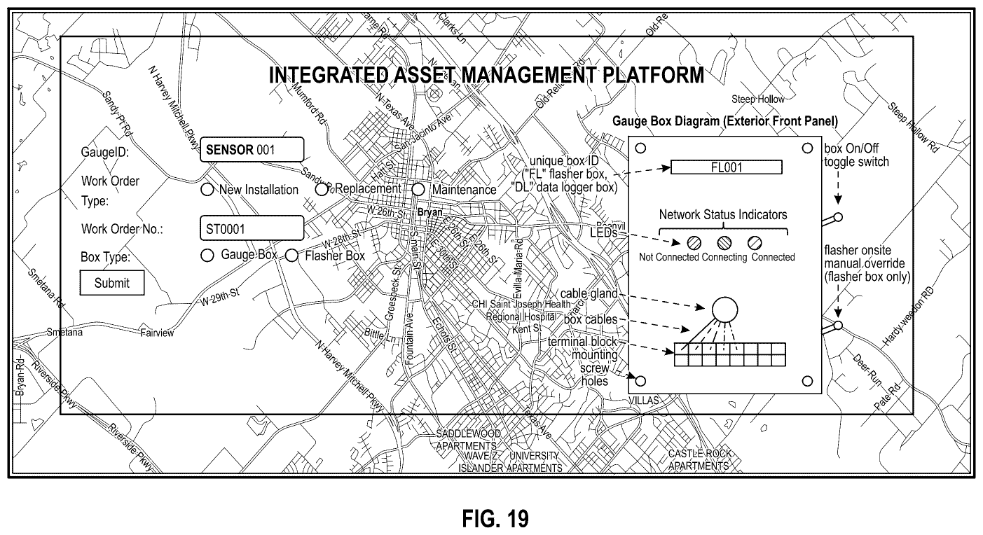

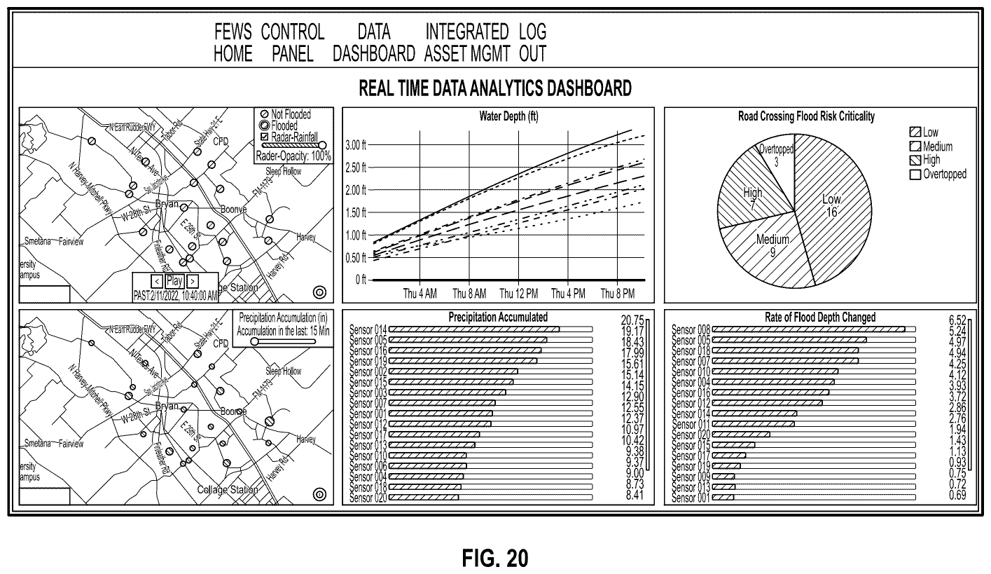

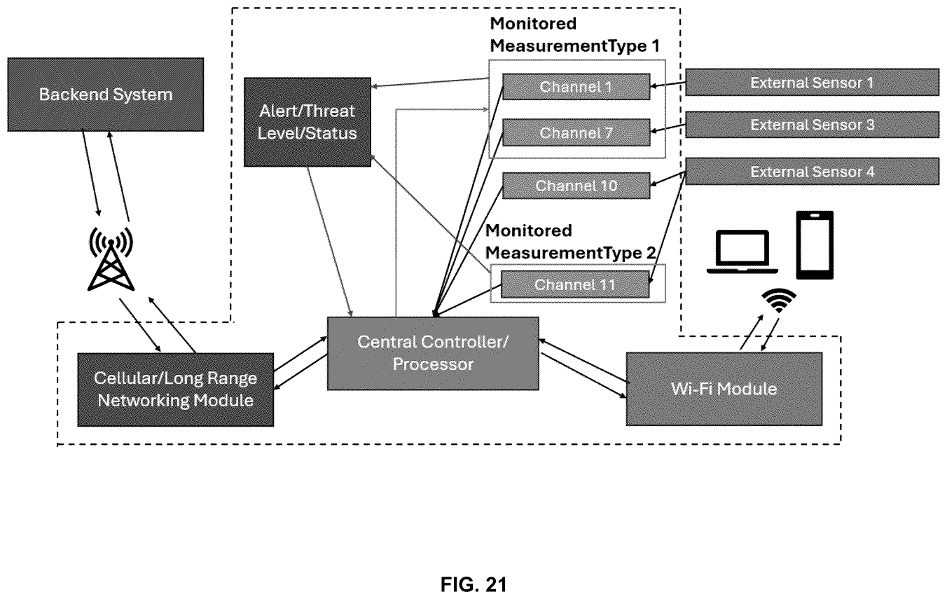

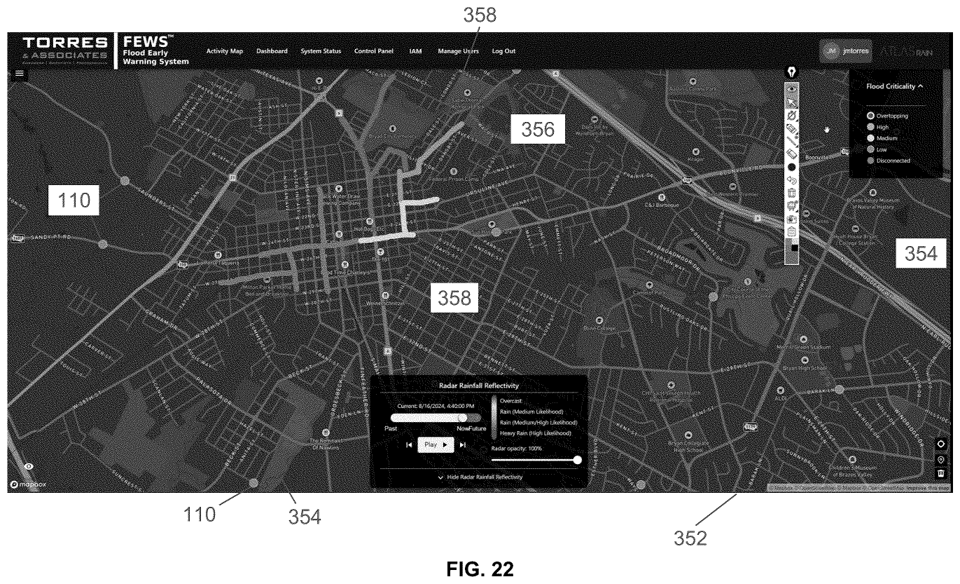

FIG. 1 is a simplified diagram of one of many embodiments of a stream gauge map according to the disclosure. FIG. 2 is the diagram of FIG. 1 overlaid with a simplified road network. FIG. 3 is the diagram of FIG. 2 showing potential low water crossings, and thus potential roadway flooding points. FIG. 4 is a simplified diagram of one of many embodiments of a flood monitoring station according to the disclosure. FIG. 5 is an image of one of many embodiments of a sensor assembly for use with a flood monitoring station according to the disclosure. FIG. 6 is an image of one of many embodiments of a flood monitoring station according to the disclosure. FIG. 7 is an image of one of many embodiments of a controller for use with a flood monitoring station according to the disclosure. FIG. 8 is an image of another one of many embodiments of a flood monitoring station according to the disclosure. FIG. 9 is a simplified diagram of one of many embodiments of a flood monitoring system according to the disclosure. FIG. 10 is a simplified diagram of another one of many embodiments of a flood monitoring system according to the disclosure. FIG. 11 is a simplified diagram of still another of many embodiments of a flood monitoring system according to the disclosure. FIG. 12 is a simplified diagram of one of many embodiments of a flood monitoring map according to the disclosure. FIG. 13 is the diagram of FIG. 12 showing one flood monitoring station warning of flooding. FIGS. 14-16 are flowcharts showing some of many embodiments of methods for providing warnings of impending or actual flooding conditions according to the disclosure. FIG. 17 is a simplified diagram illustrating aspects of one of many embodiments of a flood monitoring system according to the disclosure. FIG. 18 is a simplified diagram illustrating aspects of one of many embodiments of a control panel for a flood monitoring system according to the disclosure. FIG. 19 is a simplified diagram illustrating aspects of one of many embodiments of an asset management platform for a flood monitoring system according to the disclosure. FIG. 20 is a simplified diagram illustrating aspects of one of many embodiments of a data analytics dashboard for a flood monitoring system according to the disclosure. FIG. 21 is a simplified diagram of one of many embodiments of a flood monitoring system according to the disclosure. FIG. 22 is a simplified diagram of one of many embodiments of a flood monitoring map illustrating flood criticality according to the disclosure. FIGS. 1-22 are described in conjunction with one another.

In at least one embodiment, a system 100 for monitoring flooding can include a plurality of flood monitoring stations 110 and at least one flood warning station 160 in communication with each flood monitoring station 110. In at least one embodiment, each flood monitoring station can include one or more sensors 112, such as one or more pressure transducers or other sensors configured to detect water level. Examples of such sensors can include, but are not limited to, ultrasonic sensors, contact-based sensors, radar sensors and air bubbler sensors. In at least one embodiment, the one or more sensors 112 can include one or more atmospheric pressure sensors and/or one or more ambient temperature sensors. As other example, in at least one embodiment, system 100 can include one or more traffic sensors configured to sense traffic conditions in one or more locations (e.g., along a roadway or across a bridge), one or more noise sensors for sensing noise or noise pollution in one or more areas, and/or one or more cameras for viewing and/or recording activity in one or more locations. In at least one embodiment, a camera (if present) can provide for a real time or other camera feed at a location of interest, such as via still images, video, or both.

In at least one embodiment, each flood monitoring station 110 can include a visual warning device 114. In at least one embodiment, a visual warning device 114 can include one or more lights, such as two alternatively flashing yellow lights 114.

In at least one embodiment, each flood monitoring station 110 can include a controller 116. In at least one embodiment, the controller 116 can include a processor and a wireless communications device 118, such as a cellular network communications module and/or an antenna. As other examples, in at least one embodiment, a wireless communications device 118 can be or include a communications device configured to communicate via Wi-Fi, Bluetooth, radio and/or satellite telemetry technologies, or another wireless communication technology (whether now known or future developed), whether separately or in combination with one another and/or with cellular communications capability. In at least one embodiment, the controller 116 can include one or more batteries 120 to power its components. In at least one embodiment, the controller 116 can include one or more solar panels 122 and a solar charge controller 124 to charge the batteries 120. In at least one embodiment, any or all of the components of the flood monitoring station 110, such as the controller 116 and/or the visual warning device 114, can be mounted on a pole 130, such as in a control box or housing for at least partially enclosing one or more components of system 100 and/or for protecting one or more system components from the elements.

In at least one embodiment, the pole 130 can be located adjacent a stream bed 140, or other waterway, and/or adjacent a roadway 150. In at least one embodiment, any of the sensors 112 can be mounted within the waterway 140 or on the pole 130. In at least one embodiment, a waterway 140 and/or roadway 150 can have multiple sensors 112 and/or poles 130 adjacent thereto. For example, a pole 130 can be located along a roadway 150 on opposite sides of a waterway 140. As another example, a pole 130 can be located along a second roadway 150, such as an intersecting roadway, to indicate flooding of a first roadway 150.

In at least one embodiment, the processor of the controller 116 can be configured to determine a water level using at least one of a pressure transducer, an atmospheric pressure sensor, an ambient temperature sensor, and a combination thereof. In at least one embodiment, the processor can be configured to communicate the water level using a wireless communication device 118. In at least one embodiment, the processor can be configured to control the visual warning device 114.

In at least one embodiment, a flood warning station 160 can be in wireless communication with one or more processors at each flood monitoring station 110 through the wireless communications device 118 at each flood monitoring station 110. In at least one embodiment, the flood warning station 160 can be in direct wireless communication with the processor at each flood monitoring station 110 through the wireless communications device 118 at each flood monitoring station 110. In at least one embodiment, the flood warning station 160 can be in wireless communication with the processor at each flood monitoring station 110 through the wireless communications device 118 at each flood monitoring station 110 and/or a network 170, such as the Internet. For example, in at least one embodiment, system 100 can include a web based portal for facilitating one-way or two-way communication between or among two or more other system components, such as one or more flood monitoring stations 110, one or more flood warning stations 160 and/or other system components.

In at least one embodiment, the sensors 112 can include an ambient relative humidity sensor and/or a rainfall sensor. In at least one embodiment, the processor of the controller 116 can be configured to determine the water level using the ambient relative humidity sensor and the rainfall sensor. In at least one embodiment, the processor can be configured to determine the water level only when one or more of the ambient relative humidity sensor and the rainfall sensor indicate adverse weather. In such an embodiment, which is but one of many, system 100 advantageously can be configured for throttling back or reducing sampling rates, sensing frequency and/or other variables, e.g., during environmental conditions wherein the likelihood of flooding is low, which can reduce the amount of data transfer that takes place at one or more times and thereby can reduce operation costs.

In at least one embodiment, the processor can be configured to determine the water level periodically, such as at a first period. In at least one embodiment, the processor can be configured to communicate the water level or water level reading to the flood warning station 160 using the wireless communication device 118 periodically, such as at a second period. In at least one embodiment, the processor can be configured to communicate the water level to the flood warning station 160 using the wireless communication device 118 only when the water level exceeds a threshold, which can be or include any threshold(s) required or desired according to an implementation of the disclosure. In at least one embodiment, the threshold can be different for each flood monitoring station. In at least one embodiment, the threshold can be the same for each flood monitoring station. In at least one embodiment, the threshold can be the same for some flood monitoring stations and different for other flood monitoring stations.

In at least one embodiment, system 100 for monitoring flooding can include a web page configured to display a status of each flood monitoring station 110, such as shown in FIG. 12 and FIG. 13. In at least one embodiment, the status of each flood monitoring station can indicate whether or not the water level at each flood monitoring station 110 exceeds a threshold for each flood monitoring station 110. In at least one embodiment, the webpage can include a map that shows the location of each flood monitoring station 110 and associates a first color (such as green) and/or symbol with each flood monitoring station 110 that is not experiencing actual or predicted flooding. In at least one embodiment, the webpage can include a map that shows the location of each flood monitoring station 110 and associates a second color (such as red) and/or symbol with each flood monitoring station 110 that is experiencing actual or predicted flooding. In at least one embodiment, the webpage can include a map that shows the location of each flood monitoring station 110 and associates a third color (such as yellow) and/or symbol with each flood monitoring station 110 that is experiencing predicted, but not actual, flooding.

In at least one embodiment, the flood warning station 160 can be configured to alert a user 180, 190 when the water level at one or more of the flood monitoring stations 110 exceeds a threshold. In at least one embodiment, the flood warning station 160 can be configured to cause the processor at one or more of the flood monitoring stations 110 to trigger the visual warning device 114 upon receiving a confirmation from a controlling user 180, such as an operator or supervisor. In at least one embodiment, the processor of each flood monitoring station 110 can be configured to trigger the visual warning device 114 when the water level exceeds a threshold, with or without user intervention. In at least one embodiment, system 100 can be configured for allowing a user 180, 190 to override one or more devices or statuses at a flood monitoring station 110, such as, for example, to enable or disable the visual warning device 114 regardless of the water level reading. In at least one embodiment, system 100 can be configured for confirming receipt or nonreceipt of one or more signals or other communications transmitted or sent to one or more components of the system, such as a flood monitoring station 110 or visual warning device 114. For example, system 100 can include one or more graphical user interfaces (GUIs) for visually and/or audibly alerting a user regarding the receipt or nonreceipt of one or more signals by one or more system components.

In at least one embodiment, system 100 can be utilized by two or more classes of users 180, 190. For example, a controlling user 180, such as an operator or supervisor, can have direct control over, or communication with, any or all of the flood monitoring stations 110 and/or the flood warning station 160. In at least one embodiment, the controlling user 180 can trigger the visual warning device 114 at any or all of the flood monitoring stations 110 directly, or through the flood warning station 160. Further, in at least one embodiment, system 100 can include one or more manual overrides at any or all visual warning devices 114 and/or at any or all of flood monitoring stations 110 for enabling one or more technicians or other users in the field to override the warning status at one or more locations within system 100, if need be, such as, for example, in the event of damage to or malfunction of one or more system components.

FIG. 17 and FIG. 18 show exemplary control panel interfaces for use by the controlling user 180. In at least one embodiment, the controlling user can utilize the control panel for receiving real-time indications and providing remote override capability to online mapping conditions and the visual indicators 114. FIG. 19 shows an exemplary asset management interface that can be used to manage installation, replacement, and/or maintenance tasks associated with the flood monitoring stations 110. In at least one embodiment, this management interface can be used to organize work orders (install, repair, replacement) and manage sensor/indicator inventory. FIG. 20 shows an exemplary analytics interface for tracking and analyzing the data produced by the flood monitoring stations 110. In at least one embodiment, this analytics interface can be used to re-purpose, or represent, the sensor information into digestible formats for decision-making. Any, or all, of these interfaces can be made available to the controlling user 180 through the flood warning station 160.

In at least one embodiment, when a flood monitoring station 110 detects actual flooding, or predicts flooding, the flood monitoring station 110 and/or the flood warning station 160 can send any or all of the users 180, 190 a warning message, warning the user 180, 190 of actual or predicted flooding. In at least one embodiment, the controlling user 180 can send a confirmation message to the flood monitoring station 110 and/or the flood warning station 160, which can be used to confirm or acknowledge actual or predicted flooding. In at least one embodiment, the flood warning station 160 can send a trigger message to the flood monitoring station 110, upon receipt of the confirmation message, thereby authorizing, or triggering, the flood monitoring station 110 to trigger its visual warning device 114, thereby alerting other users 190, such as drivers in the vicinity of the actual or predicted flooding. In at least one embodiment, the controller 116, upon receipt of the confirmation message, can trigger its visual warning device 114, thereby alerting other users 190, such as drivers in the vicinity, of the actual or predicted flooding without waiting for the trigger message from the flood warning station 160. In at least one embodiment, the controller 116 can trigger its visual warning device 114, thereby alerting other users 190, such as drivers in the vicinity, of the actual or predicted flooding without waiting for the trigger message from the flood warning station 160 or the confirmation message from the user 180.

In at least one embodiment, the system 100 can utilize or include one or more networks 170, 172. For example, the flood monitoring stations 110 can communicate with the flood warning station 160 directly, or over the network 170. In at least one embodiment, the flood monitoring stations 110 can communicate with the flood warning station 160 over a private network 172, which can be completely separate from the network 170, or be a portion thereof, such as a Virtual Private Network (VPN). In at least one embodiment, the controlling user 180 can communicate with the flood monitoring stations 110 and/or the flood warning station 160 directly, or over the network 170. In at least one embodiment, the controlling user 180 can communication with the flood monitoring stations 110 and/or the flood warning station 160 over the network 170 and/or the private network 172. In at least one embodiment, the system 100 can limit the access of regular non-controlling users 190 to read/display only, such that they can be alerted of actual or predicted flooding but cannot participate in communication between the flood monitoring stations 110, the flood warning station 160, and/or the controlling user 180. Communication between the flood monitoring stations 110, the flood warning station 160, and/or the controlling user 180 can be facilitated using an Internet of Things (IoT) protocol, such as Message Queuing Telemetry Transport (MQTT).

In at least one embodiment, the processor of each flood monitoring station 110 can be configured to determine a rate of rise of the water level. In at least one embodiment, the processor of each flood monitoring station 110 can be configured to predict based on the rate of rise, a relative humidity sensor, and/or a rainfall sensor whether flooding is likely to occur. In at least one embodiment, the processor of each flood monitoring station 110 can be configured to trigger the visual warning device 114 when the processor has determined that flooding is likely to occur.

In at least one embodiment, a method 200 for monitoring flooding can include providing, or monitoring, a plurality of flood monitoring stations 110, determining, at each flood monitoring station 110, a water level, communicating wirelessly, from each flood monitoring station 110 to a flood warning station 160, a most recent water level determined by each flood monitoring station 110, and warning a user 180, 190 of flooding when one or more of the most recent water levels determined by each flood monitoring station 110 exceeds a threshold.

In at least one embodiment, each flood monitoring station 110 can include at least one pressure transducer or other sensor 112 configured to detect water level. In at least one embodiment, each flood monitoring station 110 can include at least one atmospheric pressure sensor. In at least one embodiment, each flood monitoring station 110 can include at least one ambient temperature sensor. In at least one embodiment, determining the water level can be done using at least one pressure transducer, at least one atmospheric pressure sensor, and/or at least one ambient temperature sensor.

In at least one embodiment, each flood monitoring station 110 can include a relative humidity sensor and/or a rainfall sensor. In at least one embodiment, the water level can be determined at each flood monitoring station 110 additionally using a relative humidity sensor and a rainfall sensor located at each flood monitoring station. In at least one embodiment, the water level can be determined at each flood monitoring station 110 only when one or more of a relative humidity sensor and a rainfall sensor indicate adverse weather.

In at least one embodiment, system 100 can be configured for determining or sensing water level temporally, such as at one or more times, time series and/or rates. For example, in at least one embodiment, determining a water level can be done at a first periodic rate. In at least one embodiment, communicating the most recent water level can be done wirelessly (i.e., via wireless communication) at a second periodic rate. In at least one embodiment, the first periodic rate is the same as the second periodic rate. In at least one embodiment, the first periodic rate can be less than the second periodic rate. In at least one embodiment, the first periodic rate can be greater than the second periodic rate.

In at least one embodiment, warning the user 180, 190 of flooding can include communicating wirelessly a warning message to the user 180, 190 (e.g., via an application or “app” running on a smart phone or other electronic device) from the flood warning station, directly or indirectly. In at least one embodiment, warning the user 180, 190 of flooding can include triggering a visual warning 114 at the flood monitoring station 110 that reported the water level exceeding the threshold.

In at least one embodiment, a method 200 for monitoring flooding can include receiving wirelessly, at the flood warning station 110, a confirmation message from the user 180. In at least one embodiment, a method 200 for monitoring flooding can include communicating wirelessly, upon receiving the confirmation message, from the flood warning station 160 to the flood monitoring station 110 that reported the water level exceeding the threshold, a trigger message. In at least one embodiment, the method 200 for monitoring flooding can include, upon receiving the trigger message, triggering a visual warning at the flood monitoring station that reported the water level exceeding the threshold.

In at least one embodiment, the method 200 for monitoring flooding can include calculating a rate of rise of the water level at each flood monitoring station 110. In at least one embodiment, the method 200 for monitoring flooding can include predicting based on a rate of rise, a relative humidity sensor, and/or a rainfall sensor whether flooding is likely to occur at each flood monitoring station 110. In at least one embodiment, the method 200 for monitoring flooding can include triggering a visual warning 114 at a flood monitoring station 110 where and/or when flooding is likely to occur.

In at least one embodiment, a system 100 for monitoring flooding according to the disclosure can include a plurality of flood monitoring stations 110 and at least one flood warning station 160 in communication with each flood monitoring station. Each flood monitoring station can include at least one water level sensor 112 and at least one rainfall sensor 112. Each flood monitoring station can include a housing, a processor or controller 116 and a wireless communications device 118. In at least one embodiment, each flood monitoring station 110 can determine a water level at a periodic rate and compare the water level to a threshold, determine a rainfall accumulation at a periodic rate and compare the rainfall accumulation to a threshold, assign a threat level to the flood monitoring station 110, and selectively communicate a data packet to the flood warning station 160. In at least one embodiment, a data packet can include at least one of a most recent water level, a most recent rainfall accumulation, an assigned threat level, or any combination thereof. In at least one embodiment, a flood warning station 160 can include a user interface 352 and can be arranged for selectively controlling one or more operational or other aspects of one or more flood monitoring stations 110.

In at least one embodiment, one or more flood monitoring stations 110 can determine whether an assigned threat level is above a minimum threat level threshold, and communicate a data packet to the flood warning station 160 if the assigned threat level exceeds the minimum threat level threshold. In at least one embodiment, one or more flood monitoring stations 110 can include a measurement type identifier in the data packet, and the measurement type identifier can be indicative of a type of measurement that caused an assigned threat level to exceed the minimum threat level threshold. In at least one embodiment, one or more flood monitoring stations 110 can include a sensor identifier in a data packet, and the sensor identifier can be indicative of which sensor 112 sensed the measurement that caused the assigned threat level to exceed the minimum threat level threshold. In at least one embodiment, one or more flood monitoring stations 110 can determine a rate of change in the water level and/or rainfall accumulation, compare the rate(s) of change to a rate threshold(s), and increase one or more measurement rates based on such a comparison, such as if a rate of change is greater than or equal to a rate threshold. In at least one embodiment, one or more flood monitoring stations 110 can decrease one or more measurement rates based on such a comparison, such as if a rate of change is less than or equal to a rate threshold. In at least one embodiment, one or more flood monitoring stations 110 can maintain one or more measurement rates based on such a comparison, such as if a rate of change is less than, greater than, or equal to a rate threshold.

In at least one embodiment, one or more flood monitoring stations 110 can be disposed adjacent or otherwise in operable proximity to a corresponding body of water or waterbody 354 (e.g., a stream, river, creek, drainage path, ditch, or other body for routing water during a weather event), and one or more water level sensors 112 can be disposed in sensing communication with a corresponding waterbody (which can be or include a single waterbody or multiple waterbodies). In at least one embodiment, a system 100 can include or have access to a database including flood data, such as water level sensor data, rainfall accumulation data, historical weather data, electronically stored model data, such as for a geographic area 356 located distally from one or more flood monitoring stations 110, or any combination thereof. In at least one embodiment, a system 100 can estimate, for a geographic area 356, at least one of a location of flooding, a depth of flooding, a time of flooding, or any combination thereof, such as based at least in part on data in the database. In at least one embodiment, a system 100 can display, such as on a graphical user interface 352, at least one of a location of flooding, a depth of flooding, a time of flooding, a likelihood of flooding, or any combination thereof, for one or more geographic areas 356.

In at least one embodiment, a system 100 can determine a flood criticality for one or more geographic areas. In at least one embodiment, a flood criticality can be indicative of a likelihood that flooding will occur in one or more geographic areas 356. In at least one embodiment, a system 100 can display one or more flood criticalities, such as on one or more graphical user interfaces 356. In at least one embodiment, electronically stored model data for one or more geographic areas 356 can include flood data, such as flood estimation data. In at least one embodiment, flood data can include data resulting from the application of one or more electronically stored rainstorm models to an electronically stored model of a geographic area 356.

In at least one embodiment, a method for monitoring flooding according to the disclosure can include providing a plurality of flood monitoring stations 110, each flood monitoring station including a water level sensor 112 and a rainfall sensor 112, and providing a flood warning station 160 in wireless communication with the plurality of flood monitoring stations 110. In at least one embodiment, a method can include determining a water level with a water level sensor 112 at a periodic rate and comparing the water level to a threshold, and determining a rainfall accumulation with a rainfall sensor 112 at a periodic rate and comparing the rainfall accumulation to a threshold. In at least one embodiment, a method can include assigning a threat level to a flood monitoring station 110 based on at least one of the comparisons. In at least one embodiment, a method can include communicating, from one or more flood monitoring stations 110 to a flood warning station 160, one or more data packets. In at least one embodiment, a data packet can include a most recent water level, a most recent rainfall accumulation, an assigned threat level, or any combination thereof.

In at least one embodiment, a method can include determining whether an assigned threat level is above a minimum threat level threshold, and communicating a data packet to a flood warning station 160 if the assigned threat level exceeds the minimum threat level threshold. In at least one embodiment, a method can include including a measurement type identifier in a data packet, such as a measurement type identifier indicative of a type of measurement that caused an assigned threat level to exceed a minimum threat level threshold. In at least one embodiment, a method can include including a sensor identifier in a data packet, such as a sensor identifier indicative of which sensor 112 sensed a measurement that caused an assigned threat level to exceed a minimum threat level threshold. In at least one embodiment, a method can include determining a rate of change in a water level and/or rainfall accumulation, comparing a rate of change to a threshold, and increasing a measurement rate if the rate of change is greater than or equal to the threshold.

In at least one embodiment, a method can include estimating, for a geographic area 356, such as an area located distally from one or more flood monitoring stations 110, a location of flooding, a depth of flooding, a time of flooding, or any combination thereof. In at least one embodiment, an estimation can be based at least in part on one or more determined water levels and/or rainfall accumulations. In at least one embodiment, a method can include displaying at least one of a location of flooding, a depth of flooding, a time of flooding, or any combination thereof, on a graphical user interface 352, such as of a flood warning station 160.

In at least one embodiment, a method can include determining a flood criticality for a geographic area 356, which can be a flood criticality indicative of a likelihood that flooding will occur in the geographic area 356. In at least one embodiment, a method can include displaying flood criticality on a graphical user interface 352. In at least one embodiment, a geographic area 356 can include one or more roadways 358 or portions thereof.

In at least one embodiment, a method can include creating an electronically stored model of a geographic area 356, creating an electronically stored model of a rainstorm, and applying the electronically stored model of the rainstorm to the electronically stored model of the geographic area 356. In at least one embodiment, a method can include dynamically updating a flood criticality for a geographic area 356, such as based at least in part on measured data during a weather event, historical data, modeled data, or any combination thereof. In at least one embodiment, a method can include accessing a database including water level sensor data, rainfall accumulation data, historical weather data, or any combination thereof, and creating an electronically stored predictive model of a geographic area 356. In at least one embodiment, a method can include triangulating flooding along a roadway 358 segment or other geographic area 356, such as based at least in part on one or more of measurements from one or more flood monitoring stations 110. In at least one embodiment, a method can include displaying, on a graphical user interface 352, a visual representation of flooding, such as pluvial flooding, of one or more roadway 358 segments or other portions of a geographic area 356.

In at least one embodiment, any number of sensors 112 can be included within the system 100. In at least one embodiment, one or more sensors 112 need not be the same, included within the system 100 in the same way, or use the same protocol or wiring. For example, In at least one embodiment, each sensor 100 can be connected to the system 100 and treated as a channel, such as via a channel designation assigned by system 100 software. In at least one embodiment, a channel can be used for any internal or external sensor 112 according to an implementation of the disclosure. In at least one embodiment, each channel can be or include one type of measurement from one sensor 112, such as water level, rain accumulation, or another measurement type. If a sensor 112 can produce multiple measurements, it can be assigned multiple channels, such as one channel for each measurement. In at least one embodiment, a channel can be used to interact with and record data from any physical sensor 112 within system 100. Each channel can include, for instance, information or data for identifying a measurement made, a measurement type, such as what the measurement is physically measuring, a sensor 112 making the measurement, or any combination thereof. In at least one embodiment, each sensor 112 can be configured upon installation, such as at the flood monitoring station 110, whether remotely, locally, or any combination thereof. In at least one embodiment, one or more flood monitoring stations 110 can include one or more redundant sensors 112. In at least one embodiment, such redundant sensors 112 can measure the same thing (e.g., water level or rain accumulation) across multiple channels, and each sensor measurement can have a unique channel. In at least one embodiment, such redundancies can be utilized for identifying and/or preventing sensor 112 failure and/or failure of a flood monitoring station 110.

In at least one embodiment, a system 100 can include multiple auxiliary outputs which can be used for external devices, including but not limited to devices such as flashing lights and electrical/mechanical barrier arms. The auxiliary output(s) can be triggered on and off, such as locally, remotely, or both. For example, a request can be made on a frontend site that sends information to a backend subsystem that communicates with one or more flood monitoring stations 110 over a network, such as a cellular or other network that the flood monitoring stations 110 receive from and respond to. In at least one embodiment, an auxiliary output can have different ways of outputting when enabled, such as changing which auxiliary output is triggered (if there are multiple auxiliary outputs), or how and when each auxiliary output turns on, such as on a timer. In at least one embodiment, one or more auxiliary outputs can be manually enabled/disabled from a physical switch or button on a flood monitoring station 110, a local control device such as a smart phone or computer, a control from the user interface/application of a flood warning station 160, or any combination thereof. In at least one embodiment, one or more auxiliary outputs can be enabled automatically from a flood monitoring station 110 itself, such as, for example, if the flood monitoring station 110 detects or exceeds a threshold for a threat level or other flood monitoring status.

In at least one embodiment, one or more flood monitoring stations 110 can communicate (e.g., wirelessly) one or more statuses or events to one or more other flood monitoring stations 110, whether directly, indirectly, or both. For example, in at least one embodiment, a flood monitoring station 110 can directly communicate having been triggered on or off to another flood monitoring station 110. If one flood monitoring station 110 goes off, it can send data to one or more other flood monitoring stations 110 to update their state to match the state of the sending flood monitoring station 110 as well. For instance, if one flood monitoring station 110 detects flooding, it can inform or trigger one or more other flood monitoring stations 110 to know that there is flooding too. In at least one embodiment, such a communication can trigger a receiving flood monitoring station 110 to activate or deactivate one or more auxiliary outputs, such as for a warning light or control gate. In at least one embodiment, such a communication can be made indirectly via a flood warning station 160.

In at least one embodiment, a flood monitoring station 110 can have one or more threat levels or statuses, which can be recorded and/or communicated to one or more other devices with the system 100, whether alone or in combination with other communicated data (e.g., water levels, rain accumulations, etc.). In at least one embodiment, a threat level or status can be used to report one or more conditions around the flood monitoring station 110 regarding flooding potential. For example, a threat level of a flood monitoring station 110 can be determined by one or more channels individually, or by a measurement type utilized by one or more channels. In at least one embodiment, a measurement type can be or include data for identifying what one or more sensors 112 are measuring physically (e.g., water levels, rain accumulations, etc.). In at least one embodiment, one or more measurement types can be used to identify multiple channels monitoring the same element or variable. Likewise, this can allow a threat level to be determined using information from multiple channels. Furthermore, in at least one embodiment, multiple channels and/or multiple measurement types can be monitored, and more than one physical element can be assessed to determine an overall threat level of a flood monitoring station 110. For instance, if the water level of a stream and rainfall accumulation are being measured, a threat from the amount of rainfall and a threat from the water level can be assessed, it can be determined whether either of them is passing a corresponding threshold, and a flood monitoring station 110 can report a threat level accordingly. In at least one embodiment, one or more threat levels can be determined for a given flood monitoring station 110, and the highest threat between multiple can be reported, e.g., to a flood warning station 160. In at least one embodiment, a threat level can be or include numeric data, such as, for example, an integer value from 0 to 4 (where, e.g., 0 is no threat/risk, 1 is a low threat/risk, 2 is a medium threat/risk, 3 is a high threat/risk, and 4 is a definite threat/risk) or, as another example, one or more floating-point numbers.

In at least one embodiment, a monitored measurement type can include data for defining or identifying what is being monitored or measured (e.g., water level or rain accumulation), a threshold of change that is being monitored or measured, and a threshold for one or more states or statuses of an alert/threat level/status (or “threat level”) for a corresponding flood monitoring station 110. In at least one embodiment, one or more measurement type values can be unique for any or all flood monitoring stations 110 within an implementation of system 100, such as based on the location, elevation, placement, historical weather data, and/or other factors for each flood monitoring station 110. In at least one embodiment, a monitored measurement type can be configured and/or managed on a frontend website, which can send information to a backend system, which can in turn send information to one or more flood monitoring stations 110 to configure it remotely. Alternatively, or collectively, a monitored measurement type can be configured and/or managed locally, such as through a user interface provided via either a web interface or an application in communication with a flood monitoring station 100 via Wi-Fi, BLE, hard wire, another communication path, or any combination thereof.

In at least one embodiment, one or more flood monitoring stations 110 can monitor measurements for monitored measurement types, monitor how quickly the measurements approach one or more thresholds, and determine how often to take the measurements based thereon. For example, in at least one embodiment, as a threshold is approached more quickly (e.g., as a rate of change of a measurement increases), an interval between measurements can be changed dynamically and measurements can be taken more or less often accordingly, which can improve the response time of flood monitoring station 100 and/or system 100 in times of crisis and extend battery life or otherwise reduce power consumption. For instance, a measurement interval can be increased as flooding potential increases, and decreased during dry conditions or other conditions wherein flooding potential is low.

In at least one embodiment, the data specifying each measurement type and/or each sensor 112 being monitored can include a floating-point number or other identifier representing a rate of change for a corresponding sensor 112. As described above, the rate of change (or “delta value”) can be used as a threshold for determining and dynamically changing when to take the next measurement. This feature can be referred to as “dynamic time-stepping”). For example, in at least one embodiment, flood monitoring station 110 can have a configurable maximum timestep and a configurable minimum timestep utilized for determining an interval at which flood monitoring station 110 will take and/or send the next measurements. For instance, in at least one embodiment, if there is little or no change among sensor measurements between measurements, then flood monitoring station 110 can take and/or send data at the maximum timestep. However, if there is an increasing threat, such as, for example, a water level starts rising or rainfall accumulation starts creasing, flood monitoring station 110 can monitor the rate at which it happens. Furthermore, flood monitoring station 110 can compare a magnitude of the rates with their respective delta values, and can determine how long to set the next timestep or when to take the next set of measurements. In at least one embodiment, if the change between two measurements is greater than or equal to the delta value for that sensor or measurement type, then the next timestep can be set at a selected minimum timestep.

As an illustrative example, which is but one of many, if the delta value for water level is set to be 1 foot per hour (ft/hr), and the measurements of a flood monitoring station 110 indicate the water level to be rising or receding at 1.2 ft/hour, the flood monitoring station 110 can decide to wait the configured minimum timestep before checking measurements again. For rates anywhere between 0 and the configured delta value, the flood monitoring station 110 can determine where in the range of the maximum timestep to the minimum timestep it will wait before taking the next measurement. In at least one embodiment, such a determination can be made via one or more equations. For example, in at least one embodiment, a linear relationship can be used, such as wherein a rate of 0 results in the maximum (or “max”) timestep, a rate equal to the delta value results in the minimum (or “min”) timestep, and a rate in between the two results in a next timestep equal to (max timestep)−(rate/(delta value))*((max timestep)−(min timestep)). For instance, if we have a max timestep of 900 seconds, a min timestep of 300 seconds, and a delta value for water level of 1 ft/hour, and the measured water level is rising (or falling) at 0.5 ft/hour at a given measurement, the next timestep can be 600 seconds, i.e., because 900−(0.5/1)(900-300)=600. Such an equation is but one of many, and any equation(s) or other relationship(s) can be used in accordance with an implementation of the disclosure, whether linear, exponential, a combination thereof, or otherwise. Regardless, the dynamic time-stepping according to the disclosure can improve system response times (e.g., during impending and/or actual unfavorable conditions), reduce costs, and extend system battery life. In at least one embodiment, as environmental conditions change more quickly, so too can one or more flood monitoring stations 110 take, record and/or communicate one or more measurements more often in order to better and/or more quickly monitor such changes.

In at least one embodiment, an alert/threat level/status (or “threat level”) for a corresponding flood monitoring station 110 can be or include a value for representing the then-current conditions of an area around the flood monitoring station 110. For example, higher numbers (or lower numbers, if desired) can represent greater threats, worse conditions and/or a greater likelihood of a problem (such as flooding) being present around the flood monitoring station 110. In at least one embodiment, when a flood monitoring station 110 takes a measurement (e.g., of a water level or rainfall accumulation), it can assess the threat level by comparing one or more measurement values with one or more thresholds that have been set for the flood monitoring station 110, and determine an integer or floating-point number value to represent the conditions of the area around the flood monitoring station 110. If the threat level is sufficiently high, one or more alerts can be sent by the flood monitoring station 110, such as to the flood warning station 160, and/or one or more visual warning devices 114 can be triggered. In at least one embodiment, the threat level can be assessed each time a sensor 112 takes a measurement of a corresponding condition. In at least one embodiment, the threat level can be assessed periodically, once within a given number of sensor measurements, only when a measurement is higher or lower than a given threshold, at other times or increments, or any combination thereof.

In at least one embodiment, a threat level can be assessed from multiple sources, such as multiple flood monitoring stations 110 and/or multiple sensors 112 (whether of a single flood monitoring station 110 or of multiple flood monitoring stations 110), and which source(s) and/or measurement types are monitored to determine the threat level can be specified or selected, e.g., because not all of such information may be needed to determine a given threat level in a given implementation of the disclosure. Such a configuration can advantageously help limit power usage and/or conserve other resources, such as processing capability. For example, in at least one embodiment, system 100 and/or a flood monitoring station 110 can include multiple sensors 112 measuring the same thing (e.g., backup/redundant sensors), such as the same measurement type or monitored measurement type, and a threat level can be sufficiently assessed utilizing information from less than all of such sensors. For instance, in an exemplary embodiment of flood monitoring station 110 having two sensors 112 monitoring the water level, their respective measurements can both indicate the same water level. In at least one embodiment, system 100 can monitor one sensor for a threat level, or monitor the other sensor for a threat level. In at least one embodiment, system 100 can be arranged to simply monitor “water level” and it will monitor both sensors simultaneously to determine a threat level. Similarly, if one or more additional sensors 112 are added that also monitor water level, then system 100, in at least one embodiment, can be arranged to automatically check the one or more additional sensors 112 (as well the two existing sensors of the present example) for assessing a threat level without extra configuration needed. In at least one embodiment, the data recorded and/or sent to flood warning station 160 by flood monitoring station 110 also can include a numeric value, code, or other identifier for identifying the measurement type and/or the sensor 112 underlying a corresponding threat level indication.

In at least one embodiment, a device, system and/or method according to the disclosure can utilize artificial intelligence (AI), machine learning (ML), physics-based hydrologic and/or hydraulic models, or any combination thereof, for monitoring and/or predicting flood characteristics in one or more areas, such as flood depths, flood velocities, flood timing, and/or other characteristics or variables under pluvial flood conditions for urban communities or other geographic areas. For example, in at least one embodiment, one or more AI surrogate models can be trained on input-output relationships of high-fidelity, physics-based hydrologic and hydraulic models computed under one or more sets of synthetic storms of varying precipitation depths, rates and/or durations. In this manner, one or more embodiments of the present disclosure can advantageously provide an advanced, decision-based flood warning system for urban communities and/or other geographic locations or areas. In at least one embodiment, a device, system and/or method according to the disclosure can advantageously scale point-based water level measurements to correlate linearly along one or more flooded roadway segments and/or transform gauged streamflow and/or depths into velocities for basing flood risk on fluid momentum.

In at least one embodiment, statistical error methods can be utilized to compare AI predictions against those computed from high-fidelity, physics-based models for one or more historical or other storm simulations. In at least one embodiment, results from one or more AI predictions can be translated into online or other web maps, which can be or include roadway networks discretized along lengths or segments. In at least one embodiment, one or more roadway segments can be dynamically updated and, for instance, displayed to one or more users via one or more graphical user interfaces. In at least one embodiment a display of flood status (e.g., flood criticality) can be graphically communicated to a user based on color or color coding, such as, for example, wherein red is indicative of a road segment being flooded/overtopped, orange is indicative of a high flood critically, yellow is indicative of a medium flood critically, and green is indicative of a low flood criticality.

In at least one embodiment, a system for monitoring flooding according to the disclosure can include a plurality of flood monitoring stations and at least one flood warning station in communication with each flood monitoring station. Each flood monitoring station can include at least one water level sensor and at least one rainfall sensor. Each flood monitoring station can include a housing, a processor and a wireless communications device. In at least one embodiment, each flood monitoring station can determine a water level at a periodic rate and compare the water level to a threshold, determine a rainfall accumulation at a periodic rate and compare the rainfall accumulation to a threshold, assign a threat level to the flood monitoring station, and selectively communicate a data packet to the flood warning station. In at least one embodiment, a data packet can include at least one of a most recent water level, a most recent rainfall accumulation, an assigned threat level, or any combination thereof. In at least one embodiment, a flood warning station can include a user interface and can be arranged for selectively controlling one or more operational or other aspects of one or more flood monitoring stations.

In at least one embodiment, one or more flood monitoring stations can determine whether an assigned threat level is above a minimum threat level threshold, and communicate a data packet to the flood warning station if the assigned threat level exceeds the minimum threat level threshold. In at least one embodiment, one or more flood monitoring stations can include a measurement type identifier in the data packet, and the measurement type identifier can be indicative of a type of measurement that caused an assigned threat level to exceed the minimum threat level threshold. In at least one embodiment, one or more flood monitoring stations can include a sensor identifier in a data packet, and the sensor identifier can be indicative of which sensor sensed the measurement that caused the assigned threat level to exceed the minimum threat level threshold. In at least one embodiment, one or more flood monitoring stations can determine a rate of change in the water level and/or rainfall accumulation, compare the rate(s) of change to a rate threshold(s), and increase one or more measurement rates based on such a comparison, such as if a rate of change is greater than or equal to a rate threshold.

In at least one embodiment, one or more flood monitoring stations can be disposed adjacent or otherwise in operable proximity to a corresponding waterbody with one or more water level sensors disposed in sensing communication with a corresponding waterbody. In at least one embodiment, a system can include or have access to a database including flood data, such as water level sensor data, rainfall accumulation data, historical weather data, electronically stored model data, such as for a geographic area located distally from one or more flood monitoring stations, or any combination thereof. In at least one embodiment, a system can estimate, for a geographic area, at least one of a location of flooding, a depth of flooding, a time of flooding, or any combination thereof, such as based at least in part on data in the database. In at least one embodiment, a system can display, such as on a graphical user interface, at least one of a location of flooding, a depth of flooding, a time of flooding, a likelihood of flooding, or any combination thereof, for one or more geographic areas.

In at least one embodiment, a system can determine a flood criticality for one or more geographic areas. In at least one embodiment, a flood criticality can be indicative of a likelihood that flooding will occur in one or more geographic areas. In at least one embodiment, a system can display one or more flood criticalities, such as on one or more graphical user interfaces. In at least one embodiment, electronically stored model data for one or more geographic areas can include flood data, such as flood estimation data. In at least one embodiment, flood data can include data resulting from the application of one or more electronically stored rainstorm models to an electronically stored model of a geographic area.

In at least one embodiment, a method for monitoring flooding according to the disclosure can include providing a plurality of flood monitoring stations, each flood monitoring station including a water level sensor and a rainfall sensor, and providing a flood warning station in wireless communication with the plurality of flood monitoring stations. In at least one embodiment, a method can include determining a water level with a water level sensor at a periodic rate and comparing the water level to a threshold, and determining a rainfall accumulation with a rainfall sensor at a periodic rate and comparing the rainfall accumulation to a threshold. In at least one embodiment, a method can include assigning a threat level to a flood monitoring station based on at least one of the comparisons. In at least one embodiment, a method can include communicating, from one or more flood monitoring stations to a flood warning station, one or more data packets. In at least one embodiment, a data packet can include a most recent water level, a most recent rainfall accumulation, an assigned threat level, or any combination thereof.

In at least one embodiment, a method can include determining whether an assigned threat level is above a minimum threat level threshold, and communicating a data packet to a flood warning station if the assigned threat level exceeds the minimum threat level threshold. In at least one embodiment, a method can include including a measurement type identifier in a data packet, such as a measurement type identifier indicative of a type of measurement that caused an assigned threat level to exceed a minimum threat level threshold. In at least one embodiment, a method can include including a sensor identifier in a data packet, such as a sensor identifier indicative of which sensor sensed a measurement that caused an assigned threat level to exceed a minimum threat level threshold. In at least one embodiment, a method can include determining a rate of change in a water level and/or rainfall accumulation, comparing a rate of change to a threshold, and increasing a measurement rate if the rate of change is greater than or equal to the threshold.

In at least one embodiment, a method can include estimating, for a geographic area, such as an area located distally from one or more flood monitoring stations, a location of flooding, a depth of flooding, a time of flooding, or any combination thereof. In at least one embodiment, an estimation can be based at least in part on one or more determined water levels and/or rainfall accumulations. In at least one embodiment, a method can include displaying at least one of a location of flooding, a depth of flooding, a time of flooding, or any combination thereof, on a graphical user interface, such as of a flood warning station.

In at least one embodiment, a method can include determining a flood criticality for a geographic area, which can be a flood criticality indicative of a likelihood that flooding will occur in the geographic area. In at least one embodiment, a method can include displaying flood criticality on a graphical user interface. In at least one embodiment, a geographic area can include one or more roadways or portions thereof.

In at least one embodiment, a method can include creating an electronically stored model of a geographic area, creating an electronically stored model of a rainstorm, and applying the electronically stored model of the rainstorm to the electronically stored model of the geographic area. In at least one embodiment, a method can include dynamically updating a flood criticality for a geographic area, such as based at least in part on measured data during a weather event, historical data, modeled data, or any combination thereof. In at least one embodiment, a method can include accessing a database including water level sensor data, rainfall accumulation data, historical weather data, or any combination thereof, and creating an electronically stored predictive model of a geographic area. In at least one embodiment, a method can include triangulating flooding along a roadway segment or other geographic area, such as based at least in part on one or more of measurements from one or more flood monitoring stations. In at least one embodiment, a method can include displaying, on a graphical user interface, a visual representation of flooding of one or more roadway segments.

In at least one embodiment, a method for monitoring flooding can include providing a plurality of flood monitoring stations, determining, at each flood monitoring station, a water level, communicating wirelessly, from each flood monitoring station to a flood warning station, a most recent water level determined by each flood monitoring station, and warning a user of flooding when one or more of the most recent water levels determined by each flood monitoring station exceeds a threshold. In at least one embodiment, each flood monitoring station can include at least one pressure transducer or other sensor configured to detect water level. In at least one embodiment, each flood monitoring station can include at least one atmospheric pressure sensor. In at least one embodiment, each flood monitoring station can include at least one ambient temperature sensor. In at least one embodiment, determining the water level can be done using at least one pressure transducer, at least one atmospheric pressure sensor, and/or at least one ambient temperature sensor.

In at least one embodiment, each flood monitoring station can include a relative humidity sensor and/or a rainfall sensor. In at least one embodiment, the water level can be determined at each flood monitoring station additionally using a relative humidity sensor and a rainfall sensor located at each flood monitoring station. In at least one embodiment, the water level can be determined at each flood monitoring station only when one or more of a relative humidity sensor and a rainfall sensor indicate adverse weather.

In at least one embodiment, determining the water level can be done at a first periodic rate. In at least one embodiment, communicating the most recent water level can be done wirelessly at a second periodic rate. In at least one embodiment, the first periodic rate is the same as the second periodic rate. In at least one embodiment, the first periodic rate can be less than the second periodic rate. In at least one embodiment, the first periodic rate can be greater than the second periodic rate. In at least one embodiment, warning a user of flooding can include communicating wirelessly a warning message to the user from the flood warning station. In at least one embodiment, warning the user of flooding can include triggering a visual warning at the flood monitoring station that reported the water level exceeding the threshold.

In at least one embodiment, the method for monitoring flooding can include receiving wirelessly, at the flood warning station, a confirmation message from the user. In at least one embodiment, the method for monitoring flooding can include communicating wirelessly, upon receiving the confirmation message, from the flood warning station to the flood monitoring station that reported the water level exceeding the threshold, a trigger message. In at least one embodiment, the method for monitoring flooding can include, upon receiving the trigger message, triggering a visual warning at the flood monitoring station that reported the water level exceeding the threshold.

In at least one embodiment, the method for monitoring flooding can include calculating a rate of rise of the water level at each flood monitoring station. In at least one embodiment, the method for monitoring flooding can include predicting based on a rate of rise, a relative humidity sensor, and/or a rainfall sensor whether flooding is likely to occur at each flood monitoring station. In at least one embodiment, the method for monitoring flooding can include triggering a visual warning at a flood monitoring station where and/or when flooding is likely to occur.

In at least one embodiment, a system for monitoring flooding can include a plurality of flood monitoring stations and at least one flood warning station in communication with each flood monitoring station. In at least one embodiment, each flood monitoring station can include at least one pressure transducer configured to detect water level. In at least one embodiment, each flood monitoring station can include at least one atmospheric pressure sensor. In at least one embodiment, each flood monitoring station can include at least one ambient temperature sensor. In at least one embodiment, each flood monitoring station can include a visual warning device.

In at least one embodiment, each flood monitoring station can include a processor and a wireless communications device. In at least one embodiment, the processor can be configured to determine a water level using the pressure transducer, the atmospheric pressure sensor, and the ambient temperature sensor. In at least one embodiment, the processor can be configured to communicate the water level using the wireless communication device. In at least one embodiment, the processor can be configured to control the visual warning device. In at least one embodiment, the flood warning station can be in wireless communication with the processor at each flood monitoring station through the wireless communications device at each flood monitoring station.

In at least one embodiment, each flood monitoring station can include an ambient relative humidity sensor and/or a rainfall sensor. In at least one embodiment, the processor can be configured to determine the water level using the ambient relative humidity sensor and the rainfall sensor. In at least one embodiment, the processor can be configured to determine the water level only when one or more of the ambient relative humidity sensor and the rainfall sensor indicate adverse weather.

In at least one embodiment, the processor can be configured to determine the water level periodically, such as at a first period. In at least one embodiment, the processor can be configured to communicate the water level to the flood warning station using the wireless communication device periodically, such as at a second period. In at least one embodiment, the processor can be configured to communicate the water level to the flood warning station using the wireless communication device only when the water level exceeds a threshold. In at least one embodiment, the threshold is different for each flood monitoring station.

In at least one embodiment, the system for monitoring flooding can include a web page configured to display a status of each flood monitoring station. In at least one embodiment, the status of each flood monitoring station can indicate whether or not the water level at each flood monitoring station exceeds a threshold for the flood monitoring station.

In at least one embodiment, the flood warning station can be configured to alert a user when the water level at one or more of the flood monitoring stations exceeds a threshold. In at least one embodiment, the flood warning station can be configured to cause the processor at one or more of the flood monitoring stations to trigger the visual warning device upon receiving a confirmation from the user. In at least one embodiment, the processor of each flood monitoring station can be configured to trigger the visual warning device when the water level exceeds a threshold, with or without user intervention.

In at least one embodiment, the processor of each flood monitoring station can be configured to determine a rate of rise of the water level. In at least one embodiment, the processor of each flood monitoring station can be configured to predict, based on the rate of rise, a relative humidity sensor, and a rainfall sensor whether flooding is likely to occur. In at least one embodiment, the processor of each flood monitoring station can be configured to trigger the visual warning device when the processor has determined that flooding is likely to occur.

In at least one embodiment, a method can include obtaining a water level reading with one or more flood monitoring stations, the flood monitoring station(s) including a controller, a wireless communications device in operable communication with the controller and a water level sensor in operable communication with the controller, wirelessly communicating the water level reading from a flood monitoring station to one or more flood warning stations, the flood warning station(s) including one or more displays, and displaying, on one or more displays, a visual indicator for visually indicating to a user whether the water level reading is greater than, less than or equal to a water level threshold. In at least one embodiment, a method can include wirelessly communicating at least one instruction from a flood warning station to a flood monitoring station. In at least one embodiment, a method can include wirelessly communicating at least one instruction from a flood warning station to a mobile device having a display and displaying, on the display, a visual indicator for indicating whether flooding is present in a geographical location where a flood monitoring station is located.

In at least one embodiment, a system can include one or more flood monitoring stations including a controller, a wireless communications device in operable communication with the controller and a water level sensor in operable communication with the controller, and one or more flood warning stations including one or more displays. A flood monitoring station can be configured to wirelessly communicate a water level reading from the water level sensor to a flood warning station. A flood warning station can be configured to display, on one or more displays, a visual indicator for visually indicating whether one or more water level readings are greater than, less than or equal to one or more water level thresholds. In at least one embodiment, a flood warning station can be configured to wirelessly communicate at least one instruction to a flood monitoring station. In at least one embodiment, a system can include one or more mobile devices having one or more displays, and a flood warning station can be configured to wirelessly communicate at least one instruction to one or more mobile devices, such as for causing a mobile device to display a visual indicator for indicating whether flooding is present in a geographical location where the flood monitoring station is located.

As will be appreciated by one of ordinary skill in the art having the benefits of the present disclosure, aspects of the embodiments can be embodied as a system, method or computer program product. Accordingly, aspects of the present embodiments can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing. Computer program code for carrying out operations for aspects of the present disclosure can be written in any combination of one or more programming languages, including an object oriented programming language such as Java, Smalltalk, C++, Python or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present disclosure can be and/or are described with reference to flowchart illustrations and/or block diagrams of methods, apparatus (systems) and computer program products according to embodiments of the disclosure. Each block of a flowchart illustration and/or block diagram, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions can also be stored in a computer readable medium (which can be or include any non-transitory computer readable media) that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions can also be loaded onto a computer, other programmable data processing apparatus, or other devices to cause a series of operational steps to be performed on the computer, other programmable apparatus or other device(s) to produce a computer implemented process such that the instructions which execute on the computer or other programmable apparatus provide processes for implementing the functions/acts specified in a flowchart and/or block diagram block or blocks.

Other and further embodiments utilizing one or more aspects of the disclosure can be devised without departing from the spirit of Applicants' disclosure. For example, the devices, systems and methods can be implemented for numerous different types and sizes of flood warning arrangements, including scalable arrangements, in numerous different localities or geographical areas. As other examples, one or more devices, systems and methods of the disclosure can be configured for other sensor peripherals or implementations, whether separately or in combination with flood warning functionality. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the claims.

What is claimed is:

1. A system for monitoring flooding, the system comprising:
a plurality of flood monitoring stations, each flood monitoring station including a housing, a water level sensor, a rainfall sensor, a processor, and a wireless communications device; and
a flood warning station in wireless communication with the processor at each flood monitoring station via the wireless communications device at each flood monitoring station;
wherein the processor at each flood monitoring station is configured to:
determine a water level with the water level sensor at a first periodic rate and compare the water level to a first threshold;
determine a rainfall accumulation with the rainfall sensor at a second periodic rate and compare the rainfall accumulation to a second threshold;
assign a threat level to the flood monitoring station based on at least one of the comparison to the first threshold, the comparison to the second threshold, and a combination thereof; and
communicate wirelessly, to the flood warning station, a data packet comprising at least one of a most recent water level, a most recent rainfall accumulation, an assigned threat level, and a combination thereof.

2. The system of claim 1, wherein the processor at each flood monitoring station is further configured to determine whether the assigned threat level is above a minimum threat level threshold, and communicate the data packet to the flood warning station if the assigned threat level exceeds the minimum threat level threshold.

3. The system of claim 2, wherein the processor at each flood monitoring station is further configured to include a measurement type identifier in the data packet, wherein the measurement type identifier is indicative of a type of measurement that caused the assigned threat level to exceed the minimum threat level threshold.

4. The system of claim 3, wherein the processor at each flood monitoring station is further configured to include a sensor identifier in the data packet, wherein the sensor identifier is indicative of which sensor sensed the measurement that caused the assigned threat level to exceed the minimum threat level threshold.

5. The system of claim 1, wherein the processor at each flood monitoring station is further configured to determine a rate of change in the water level and/or rainfall accumulation, compare the rate of change to a rate threshold, and increase the first periodic rate and/or the second periodic rate if the rate of change is greater than or equal to the rate threshold.

6. The system of claim 1,
wherein each of the plurality of flood monitoring stations is disposed adjacent to a corresponding waterbody with the water level sensor disposed in sensing communication with the corresponding waterbody;
wherein the system comprises or has access to a database comprising water level sensor data, rainfall accumulation data, historical weather data, and electronically stored model data for a geographic area located distally from the plurality of flood monitoring stations;
wherein the system is configured to estimate, for the geographic area, at least one of a location of flooding, a depth of flooding, a time of flooding, and a combination thereof, based at least in part on data in the database; and
wherein the system is configured to display, on a graphical user interface of the flood warning station, at least one of the location of flooding, the depth of flooding, the time of flooding, and a combination thereof, for the geographic area.

7. The system of claim 6, wherein the system is further configured to determine a flood criticality for the geographic area, wherein the flood criticality is indicative of the likelihood that flooding will occur in the geographic area, and display the flood criticality on the graphical user interface.

8. The system of claim 6, wherein the electronically stored model data for the geographic area comprises flood estimation data resulting from the application of one or more electronically stored rainstorm models to an electronically stored model of the geographic area.

9. A method for monitoring flooding, the method comprising:
providing a plurality of flood monitoring stations, each flood monitoring station including a water level sensor and a rainfall sensor;
providing a flood warning station in wireless communication with the plurality of flood monitoring stations;
at each flood monitoring station:
determining a water level with the water level sensor at a first periodic rate and comparing the water level to a first threshold;
determining a rainfall accumulation with the rainfall sensor at a second periodic rate and comparing the rainfall accumulation to a second threshold; and
assigning a threat level to the flood monitoring station based on at least one of the comparison to the first threshold, the comparison to the second threshold, and a combination thereof; and
communicating wirelessly, from at least one of the plurality of flood monitoring stations to the flood warning station, a data packet comprising at least one of a most recent water level, a most recent rainfall accumulation, an assigned threat level, and a combination thereof.

10. The method of claim 9, further comprising determining whether the assigned threat level is above a minimum threat level threshold, and communicating the data packet to the flood warning station only if the assigned threat level exceeds the minimum threat level threshold.

11. The method of claim 10, further comprising including a measurement type identifier in the data packet, wherein the measurement type identifier is indicative of a type of measurement that caused the assigned threat level to exceed the minimum threat level threshold.

12. The method of claim 11, further comprising including a sensor identifier in the data packet, wherein the sensor identifier is indicative of which sensor sensed the measurement that caused the assigned threat level to exceed the minimum threat level threshold.

13. The method of claim 9, further comprising determining a rate of change in the water level, comparing the rate of change to a rate threshold, and increasing the first periodic rate if the rate of change is greater than or equal to the rate threshold.

14. The method of claim 9, further comprising determining a rate of change in the rainfall accumulation, comparing the rate of change to a rate threshold, and increasing the second periodic rate if the rate of change is greater than or equal to the rate threshold.

15. The method of claim 9, wherein each of the plurality of flood monitoring stations is disposed adjacent to a corresponding waterbody with the water level sensor disposed in sensing communication with the corresponding waterbody, and wherein the method further comprises:
estimating, for a geographic area located distally from the plurality of flood monitoring stations, at least one of a location of flooding, a depth of flooding, a time of flooding, and a combination thereof, based at least in part on one or more of the determined water level and the determined rainfall accumulation; and
displaying at least one of the location of flooding, the depth of flooding, the time of flooding, and a combination thereof, on a graphical user interface of the flood warning station.

16. The method of claim 15, further comprising determining a flood criticality for the geographic area, wherein the flood criticality is indicative of the likelihood that flooding will occur in the geographic area; and displaying the flood criticality on the graphical user interface.

17. The method of claim 16, wherein the geographic area comprises a segment of roadway.

18. The method of claim 16, further comprising:
creating an electronically stored model of the geographic area;
creating an electronically stored model of a rainstorm;
applying the electronically stored model of the rainstorm to the electronically stored model of the geographic area; and
dynamically updating the flood criticality for the geographic area.

19. The method of claim 15, further comprising accessing a database comprising water level sensor data, rainfall accumulation data, and historical weather data; and creating an electronically stored predictive model of the geographic area.

20. The method of claim 9, further comprising electronically triangulating flooding along a roadway segment based at least in part on one or more of the determined water level and the determined rainfall accumulation from each of the plurality of flood monitoring stations; and displaying, on a graphical user interface of the flood warning station, a visual representation of flooding of the roadway segment.
